(19) United States
(12) Patent Application Publication
(10) Pub. No.: US 2018/0276463 A1
(43) Pub. Date: Sep. 27, 2018

(54) OPTICALLY DETECTABLE MARKERS

(71) Applicant: VRstudios Inc., Bellevue, WA (US)

(72) Inventor: John Michael Pritz, Mercer Island, WA (US)

(73) Assignee: VRstudios Inc., Bellevue, WA (US)

(21) Appl. No.: 15/470,797

(22) Filed: Mar. 27, 2017

(51) Int. Cl. G06K 9/00; G01B 11/14

(52) U.S. Cl. CPC G06K 9/00577; G01B 11/14; G06K 9/00369; G06K 9/00771

(57) ABSTRACT

The current document is directed to optically detectable markers that uniquely identify entities within a physical environment monitored by an automated, camera-based monitoring system and to methods for generating the sets of different, uniquely identifiable optically detectable markers. An optically detectable marker generated by the currently disclosed methods includes multiple individual optical markers positioned in space so that the arrangement of the multiple optical markers lacks rotational symmetry, ensuring that the orientation of the optically detectable marker can be unambiguously determined by the automated camera-based optical monitoring system.

### TECHNICAL FIELD

The current document is directed to optically detectable markers and methods for generating optically detectable markers and, in particular, to optically detectable markers used to detect the positions and orientations of participants and objects in a camera-monitored environment.

### BACKGROUND

The development of automated, camera-based monitoring systems, computer networking, and modern servers and workstations that economically provide high computational bandwidths has enabled the development of sophisticated camera-based optical monitoring systems that continuously monitor environments in order to track the positions and orientations of various entities within the environment. These types of camera-based optical-monitoring systems are used for monitoring manufacturing processes, human and vehicle traffic, and many additional types of moving entities within many additional types of environments. More recently, significant efforts have been invested in developing lifelike virtual-reality systems that allow participants wearing electronic headsets within a well-defined physical environment to experience a computationally-generated virtual environment. Virtual-reality environments may include as yet unbuilt homes, offices, and buildings that can be virtually toured by participants, representations of biomolecules that can be viewed and manipulated by participants in order to study the structure of biomolecules and their interactions with one another, and a wide variety of different virtual-reality-gaming environments in which participants interact with one another and with the virtual-reality-gaming environments to participate in games.

In many virtual-reality environments, a lifelike virtual-reality experience is provided to participants by optically monitoring the positions and orientations of the participants and other physical objects within a well-defined physical environment in which participants can move about and interact while experiencing the virtual-reality environments. A virtual-reality system, continuously receiving data representing the precise locations and orientations of participants and physical objects in a physical environment, computes and displays position-and-orientation-adapted visual and audio components of the virtual environment to participants through electronic headsets. In order to provide realistic virtual environments to participants, the virtual-reality system uses optically detectable markers affixed to participants and physical objects in the physical environment to continuously identify the positions and orientations of each of the participants and physical objects in real time via an automated camera-based monitoring subsystem. Currently, the optically detectable markers, which need to be uniquely identifiable by the automated camera-based optical monitoring subsystem, are constructed in an ad hoc, empirical fashion. However, as virtual-reality systems become increasingly used in commercial settings, construction of optically detectable markers by ad hoc and empirical methods is inadequate to ensure that the optically detectable markers are uniquely identifiable and that the orientations of the optically detectable markers can be unambiguously determined.

### SUMMARY

The current document is directed to optically detectable markers that uniquely identify entities within a physical environment monitored by an automated, camera-based monitoring system and to methods for generating the sets of different, uniquely identifiable optically detectable markers. An optically detectable marker generated by the currently disclosed methods includes multiple individual optical markers positioned in space so that the arrangement of the multiple optical markers lacks rotational symmetry, ensuring that the orientation of the optically detectable marker can be unambiguously determined by the automated camera-based optical monitoring system. The number of individual optical markers can be selected so that, even in the case when a subset of the individual optical markers are obscured and undetectable by the automated camera-based optical monitoring system, the optically detectable marker provides a sufficient optical signal to be uniquely identifiable by the automated camera-based optical monitoring system and for the automated camera-based optical monitoring system to unambiguously determine a position and orientation of the optically detectable marker in three-dimensional space.

### BRIEF DESCRIPTION OF THE DRAWINGS

FIG. 1 illustrates a physical environment in which participants are monitored by an automated camera-based monitoring system.

FIGS. 2A-3E illustrate a mathematical approach to the determination of the coordinates of a point imaged by two or more optical cameras.

FIGS. 4A-C illustrate assembly of an optically detectable marker.

FIGS. 5-6E illustrate the currently described methods for constructing optically detectable markers that produce sets of optically detectable markers in which each optically-detectable-marker member is uniquely distinguishable from the other members of the set by an automated, camera-based monitoring system and each optically-detectable-marker member provides a sufficient optical signal, regardless of orientation, to allow the automated camera-based automation system to unambiguously determine the orientation of the optically detectable marker in three-dimensional space.

FIGS. 7A-E provide control-flow diagrams that illustrate one implementation of a system and method for generating positions objects that each describe an arrangement of optical markers in three-dimensional space that lack rotational symmetry and that meet various distance constraints.

FIGS. 8A-D illustrate a further consideration in the construction of optically detectable markers.

FIGS. 9A-B illustrate an implementation of a method that generates a set of positions objects with a minimum number of anchors.

### DETAILED DESCRIPTION

The current document is directed to optically detectable markers and to methods for generating sets of different, uniquely identifiable optically detectable markers used to label participants and objects in camera-monitored environments. As one example, the currently disclosed optically detectable markers are used in virtual-reality-gaming environments to uniquely optically label participants and physical objects within a physical environment in which the participants experience a virtual-reality-gaming environment through electronic headsets.

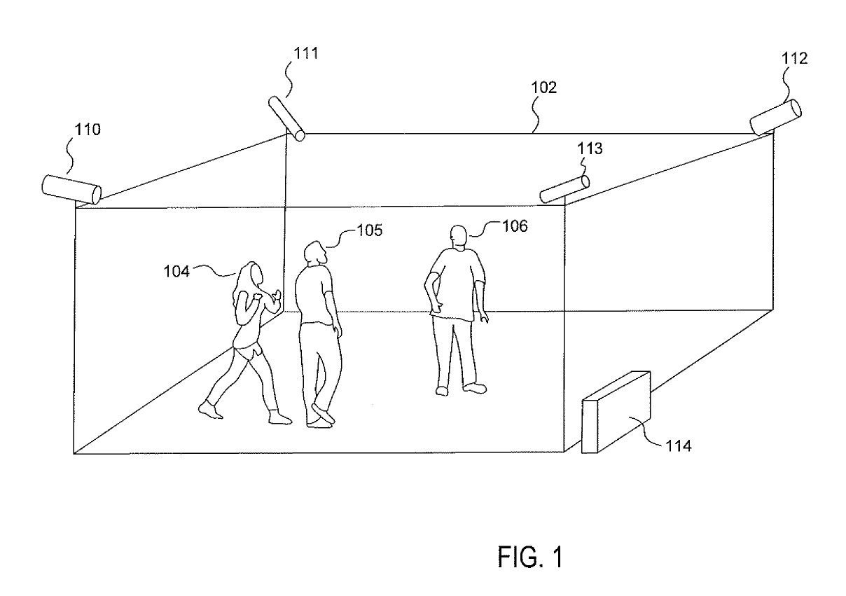

FIG. 1 illustrates a physical environment in which participants are monitored by an automated camera-based monitoring system. In the example shown in FIG. 1, the monitored environment is a rectangular volume 102 in which three participants 104-106 can freely move and interact with one another. A number of infrared cameras 110-113 are mounted in fixed locations to continuously record images of the environment and of the three participants within the environment. The continuously captured images are transmitted, via wireless or wired electronic communications, to a computer system 114 that receives and processes the transmitted images in order to determine the positions and orientations of the three participants 104-106 in real time. In a virtual-reality system, the participants wear headsets through which the participants receive audio and visual representations of a virtual environment continuously transmitted to the headsets by a virtual-reality computer system. The virtual-reality computer system continuously receives the determined positions and orientations of the participants and other physical objects within the monitored environment from the automated camera-based monitoring-system computer system 114. The virtual-reality system uses the received positions and orientations of the participants and other physical objects in order to a different, provide real-time position-and-orientation-dependent virtual-reality representations to each of the three participants. By contrast, in a monitored manufacturing environment, the participants may be robots that cooperate to perform assembly-line tasks. In this environment, a process-control system may use the continuously received orientation-and-position information provided by an automated, camera-based monitoring subsystem to continuously transmit real-time control instructions to each of the robots.

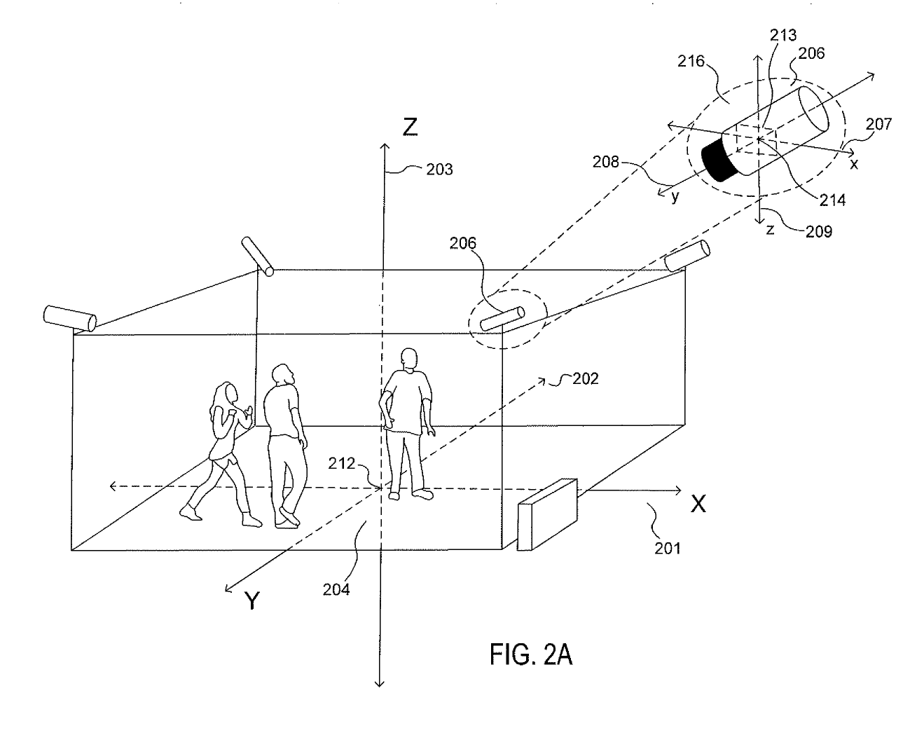

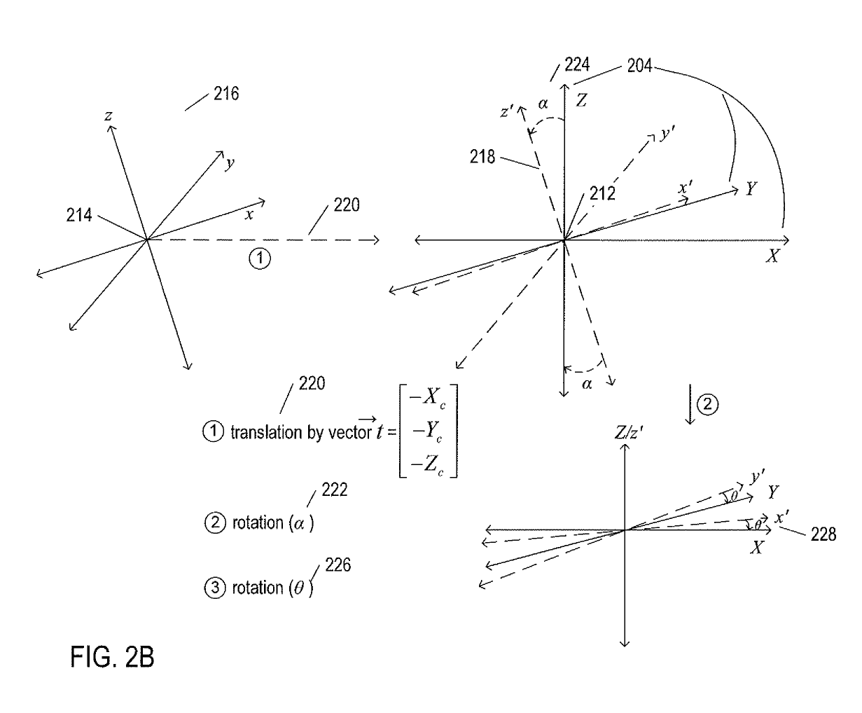

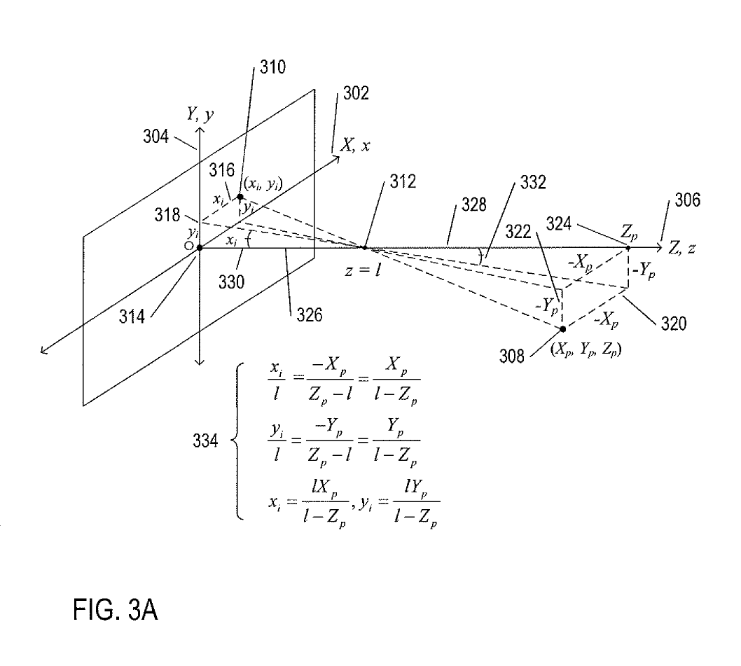

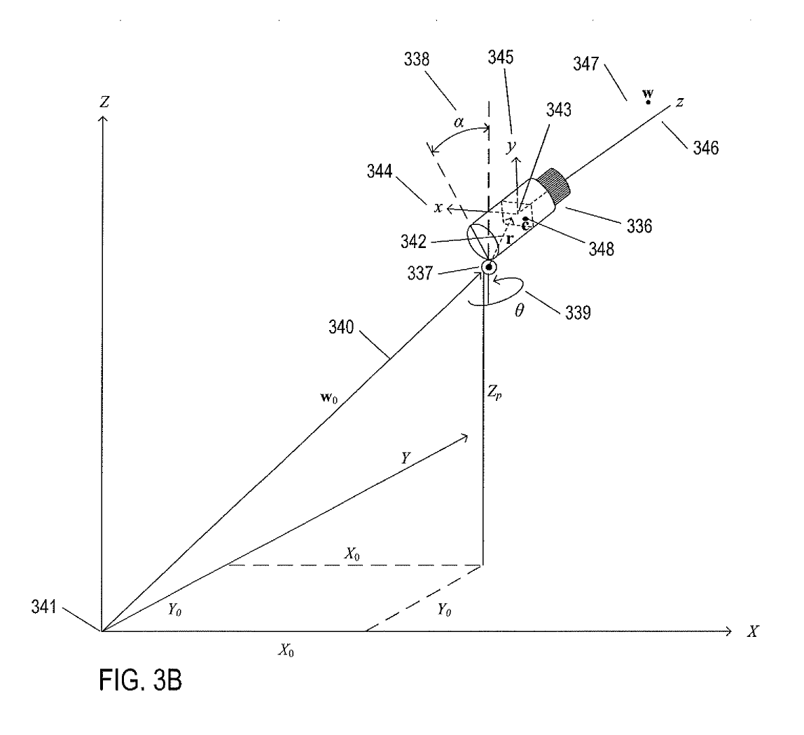

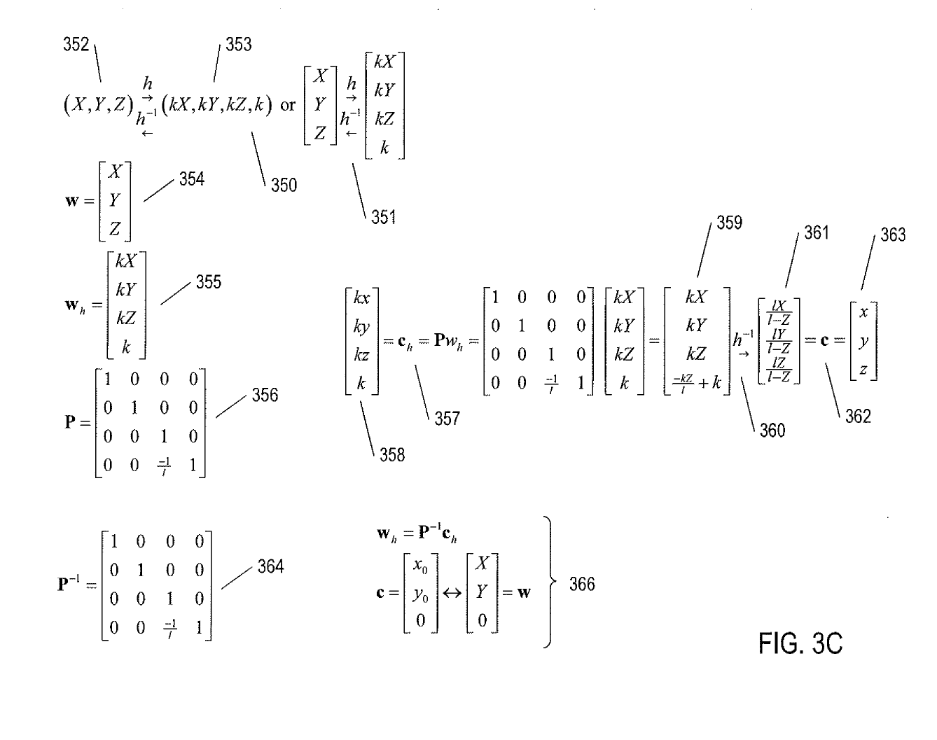

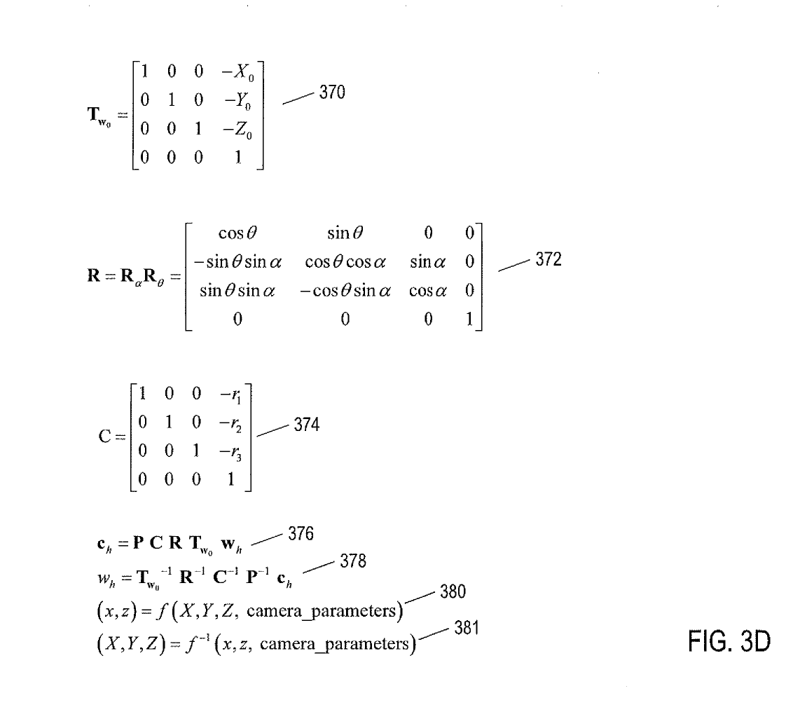

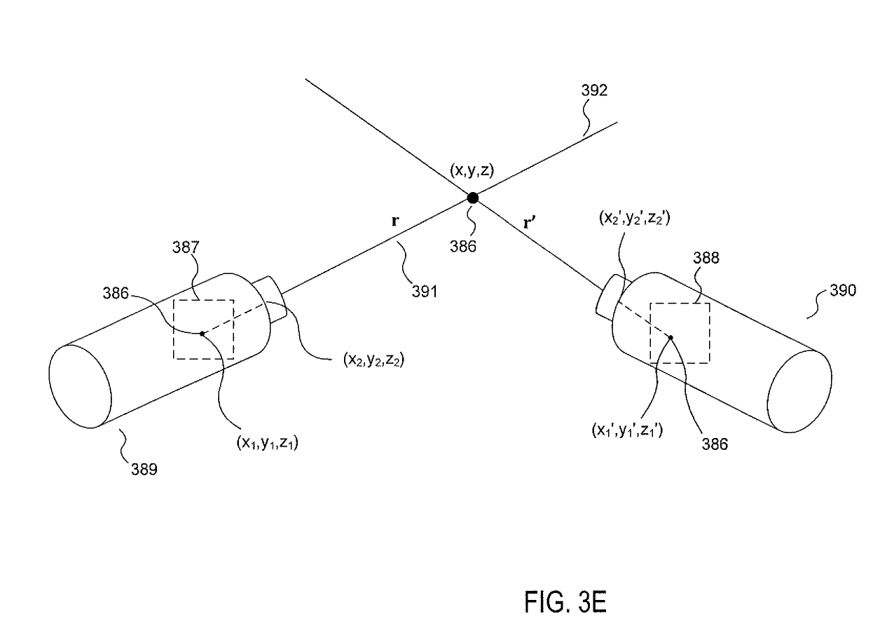

FIGS. 2A-3E illustrate a mathematical approach to the determination of the coordinates of a point imaged by two or more optical cameras. FIGS. 2A-B illustrate the relationship between a camera position and an environment monitored by an automated, camera-based monitoring system. As shown in FIG. 2A, the monitored environment is assigned a three-dimensional world coordinate system 204 having three mutually orthogonal axes X 201, Y 202, and Z 203. A two-dimensional view of the three-dimensional model can be obtained, from any position within the world coordinate system, by image capture using a camera 206. The camera 206 is associated with its own three-dimensional coordinate system 216 having three mutually orthogonal axes x 207, y 208, and z 209. The world coordinate system and the camera coordinate system are, of course, mathematically related by a translation of the origin 214 of the camera x, y, z coordinate system from the origin 212 of the world coordinate system and by three rotation angles that, when applied to the camera, rotate the camera x, y, and z coordinate system with respect to the world X, Y, Z coordinate system. The origin 214 of the camera x, y, z coordinate system has the coordinates (0, 0, 0) in the camera coordinate system and the coordinates (X_{c}, Y_{c}, and Z_{c}) in the world coordinate system. A two-dimensional image captured by the camera 213 can be thought of as lying in the x, z plane of the camera coordinate system and centered at the origin of the camera coordinate system, as shown in FIG. 2A.

FIG. 2B illustrates operations involved with orienting and positioning the camera x, y, z coordinate system to be coincident with the world X, Y, Z coordinate system. In FIG. 2B, the camera coordinate system 216 and world coordinate system 204 are centered at two different origins, 214 and 212, respectively, and the camera coordinate system is oriented differently than the world coordinate system. In order to orient and position the camera x, y, z coordinate system to be coincident with the world X, Y, Z coordinate system, three operations are undertaken. A first operation 220 involves translation of the camera-coordinate system, by a displacement represented by a vector t, so that the origins 214 and 212 of the two coordinate systems are coincident. The position of the camera coordinate system with respect to the world coordinate system is shown with dashed lines, including dashed line 218, with respect to the world coordinate system following the translation operation 220. A second operation 222 involves rotating the camera coordinate system by an angle α (224) so that the z axis of the camera coordinate system, referred to as the z′ axis following the translation operation, is coincident with the Z axis of the world coordinate system. In a third operation 226, the camera coordinate system is rotated about the Z/z′ axis by an angle θ (228) so that all of the camera-coordinate-system axes are coincident with their corresponding world-coordinate-system axes.

FIGS. 3A-D illustrate one approach to mapping points in the world coordinate system to corresponding points on the image plane of a camera. This process allows cameras to be positioned anywhere within space with respect to the computational world coordinate system and used to generate a two-dimensional image that can be partially mapped back to the world coordinate system. FIG. 3A illustrates the image plane of a camera, an aligned camera coordinate system and world coordinate system, and a point in three-dimensional space that is imaged on the image plane of the camera. In FIG. 3A, and in FIGS. 3B-D that follow, the camera coordinate system, comprising the x, y, and z axes, is aligned and coincident with the world-coordinate system X, Y, and Z. This is indicated, in FIG. 3A, by dual labeling of the x and X axis 302, the y and Y axis 304, and the z and Z axis 306. A point 308 that is imaged is shown to have the coordinates (X, Y, and Z). The image of this point on the camera image plane 310 has the coordinates (xᵢ, yᵢ). The lens of the camera is centered at the point 312, which has the camera coordinates (0, 0, l) and the world coordinates (0, 0, l). When the point 308 is in focus, the distance l between the origin 314 and point 312 is the focal length of the camera. Note that, in FIG. 3A, the z axis is used as the axis of symmetry for the camera rather than the y axis, as in FIG. 2A. A small rectangle is shown, on the image plane, with the corners along one diagonal coincident with the origin 314 and the point 310 with coordinates (xᵢ, yᵢ). The rectangle has horizontal sides, including horizontal side 316, of length xᵢ, and vertical sides, including vertical side 318, with lengths yᵢ. A corresponding rectangle with horizontal sides of length −Xₚ, including horizontal side 320, and vertical sides of length −Yₚ, including vertical side 322. The point 308 with world coordinates Xₚ, Yₚ, and Zₚ) and the point 324 with world coordinates (0, 0, Zₚ) are located at the corners of one diagonal of the corresponding rectangle. Note that the positions of the two rectangles are inverted through point 312. The length of the line segment 328 between point 312 and point 324 is Zₚ−l. The angles at which each of the lines passing through point 312 intersects the z, Z axis are equal on both sides of point 312. For example, angle 330 and angle 332 are identical. As a result, the principal of the correspondence between the lengths of similar sides of similar triangles can be used to derive expressions for the image-plane coordinates (xᵢ, yᵢ) for an imaged point in three-dimensional space with world coordinates (Xₚ, Yₚ, and Zₚ) 334:

$$\frac{{x}_{i}}{l} = \frac{- {X}_{p}}{{Z}_{p} - l} = \frac{{X}_{p}}{l - {Z}_{p}}$$

$$\frac{{y}_{i}}{l} = \frac{- {Y}_{p}}{{Z}_{p} - l} = \frac{{Y}_{p}}{l - {Z}_{p}}$$

$${x}_{i} = \frac{{lX}_{p}}{l - {Z}_{p}} , {y}_{i} = \frac{{lY}_{p}}{l - {Z}_{p}}$$

Of course, camera coordinate systems are not, in general, aligned with the world coordinate system, as discussed above with reference to FIG. 2A. Therefore, a slightly more complex analysis is required to develop the functions, or processes, that map points in three-dimensional space to points on the image plane of a camera. FIGS. 3B-D illustrate the process for computing the image of points in a three-dimensional space on the image plane of an arbitrarily oriented and positioned camera. FIG. 3B shows the arbitrarily positioned and oriented camera. The camera 336 is mounted to a mount 337 that allows the camera to be tilted by an angle α 338 with respect to the vertical Z axis and to be rotated by an angle θ 339 about a vertical axis. The mount 337 can be positioned anywhere in three-dimensional space, with the position represented by a position vector w₀ 340 from the origin of the world coordinate system 341 to the mount 337. A second vector r 342 represents the relative position of the center of the image plane 343 within the camera 336 with respect to the mount 337. The orientation and position of the origin of the camera coordinate system coincides with the center of the image plane 343 within the camera 336. The image plane 343 lies within the x, y plane of the camera coordinate axes 344-346. The camera is shown, in FIG. 3B, imaging a point w 347, with the image of the point w appearing as image point c 348 on the image plane 343 within the camera. The vector w₀ that defines the position of the camera mount 337 is shown, in FIG. 3B, to be the vector

wₒ=|Yₒ^{u}|

FIGS. 3C-D show the process by which the coordinates of a point in three-dimensional space, such as the point corresponding to vector w in world-coordinate-system coordinates, is mapped to the image plane of an arbitrarily positioned and oriented camera. First, a transformation between world coordinates and homogeneous coordinates h and the inverse transformation h⁻¹ is shown in FIG. 3C by the expressions 350 and 351. The forward transformation from world coordinates 352 to homogeneous coordinates 353 involves multiplying each of the coordinate components by an arbitrary constant k and adding a fourth coordinate component k. The vector w corresponding to the point 347 in three-dimensional space imaged by the camera is expressed as a column vector, as shown in expression 354 in FIG. 3C. The corresponding column vector wₕ in homogeneous coordinates is shown in expression 355. The matrix P is the perspective transformation matrix, shown in expression 356 in FIG. 3C. The perspective transformation matrix is used to carry out the world-to-camera coordinate transformations (334 in FIG. 3A) discussed above with reference to FIG. 3A. The homogeneous-coordinate-form of the vector c corresponding to the image 348 of point 347, cₕ, is computed by the left-hand multiplication of wₕ by the perspective transformation matrix, as shown in expression 357 in FIG. 3C. Thus, the expression for cₕ in homogeneous camera coordinates 358 corresponds to the homogeneous expression for cₕ in world coordinates 359. The inverse homogeneous-coordinate transformation 360 is used to transform the latter into a vector expression in world coordinates 361 for the vector c 362. Comparing the camera-coordinate expression 363 for vector c with the world-coordinate expression for the same vector 361 reveals that the camera coordinates are related to the world coordinates by the transformations (334 in FIG. 3A) discussed above with reference to FIG. 3A. The inverse of the perspective transformation matrix, P⁻¹, is shown in expression 364 in FIG. 3C. The inverse perspective transformation matrix can be used to compute the world-coordinate point in three-dimensional space corresponding to an image point expressed in camera coordinates, as indicated by expression 366 in FIG. 3C. Note that, in general, the Z coordinate for the three-dimensional point imaged by the camera is not recovered by the inverse of the perspective transformation. This is because all of the points in front of the camera along the line from the image point to the imaged point are mapped to the image point. Additional information is needed to determine the Z coordinate for three-dimensional points imaged by the camera, such as depth information obtained from a set of stereo images or depth information obtained by a separate depth sensor.

Three additional matrices are shown in FIG. 3D that represent the position and orientation of the camera in the world coordinate system. The translation matrix T_{w}_{₀} 370 represents the translation of the camera mount (337 in FIG. 3B) from its position in three-dimensional space to the origin (341 in FIG. 3B) of the world coordinate system. The matrix R represents the α and θ rotations needed to align the camera coordinate system with the world coordinate system 372. The translation matrix C 374 represents translation of the image plane of the camera from the camera mount (337 in FIG. 3B) to the image plane's position within the camera represented by vector r (342 in FIG. 3B). The full expression for transforming the vector for a point in three-dimensional space wₕ into a vector that represents the position of the image point on the camera image plane cₕ is provided as expression 376 in FIG. 3D. The vector wₕ is multiplied, from the left, first by the translation matrix 370 to produce a first intermediate result, the first intermediate result is multiplied, from the left, by the matrix R to produce a second intermediate result, the second intermediate result is multiplied, from the left, by the matrix C to produce a third intermediate result, and the third intermediate result is multiplied, from the left, by the perspective transformation matrix P to produce the vector cₕ. Expression 378 shows the inverse transformation. Thus, in general, there is a forward transformation from world-coordinate points to image points 380 and, when sufficient information is available, an inverse transformation 381. It is the forward transformation 380 that is used to generate two-dimensional images from a three-dimensional environment. Each point in the three-dimensional environment is transformed by forward transformation 380 to points on the image plane of the camera.

FIG. 3E illustrates obtaining additional depth information based on images captured from two cameras in order to provide sufficient information for the reverse transformation (381 in FIG. 3D) from image coordinates to world coordinates. The world coordinates for a particular point in the environment 386 are (X,Y,Z). If the point can be identified in the two images 387 and 388 acquired by two differently positioned cameras 389 and 390, then, using the image and World coordinates for the point in each image as well as the world coordinates for reference points along the light ray from the point to the images of the point, the directions and positions of the light rays 391 and 392 and be determined. Using that information, the world Z coordinate for the point can be unambiguously determined as the Z coordinate of the point of intersection of the two light rays. But, this method of determining the world coordinates, and therefore location, of the point depends on identifying the point in images captured by two or more cameras. That is why the currently disclosed optically identifiable markers are needed. They allow an automated, camera-based monitoring system to uniquely identify each optically identifiable marker in multiple images form different cameras in order to determine the world coordinates of the optically identifiable markers by the method discussed above. Furthermore, because an optically identifiable marker produces a different two-dimensional image for each different orientation, the automated, camera-based monitoring system can compute the orientation of the optically identifiable marker by rotating and scaling a model of the optically identifiable marker to generate a plane projection of the model normal to the plane of an acquired image that best fits the image, and therefore determine an orientation of the optically identifiable marker.

In order to provide an optically detectable marker that can be a fit affixed to participants and objects in a monitored environment to allow an automated camera-based monitoring subsystem to determine the positions and orientations participants and physical objects in a monitored environment, optically detectable markers need to be designed to have unique optical signatures or, in other words, to provide unique images, that can be readily identified by the automated camera-based monitoring subsystem. In addition, the optically detectable markers need to be recognizable by the automated, camera-based monitoring subsystem regardless of their orientations and furnish sufficient information to allow their orientations to be determined by the automated camera-based monitoring subsystem.

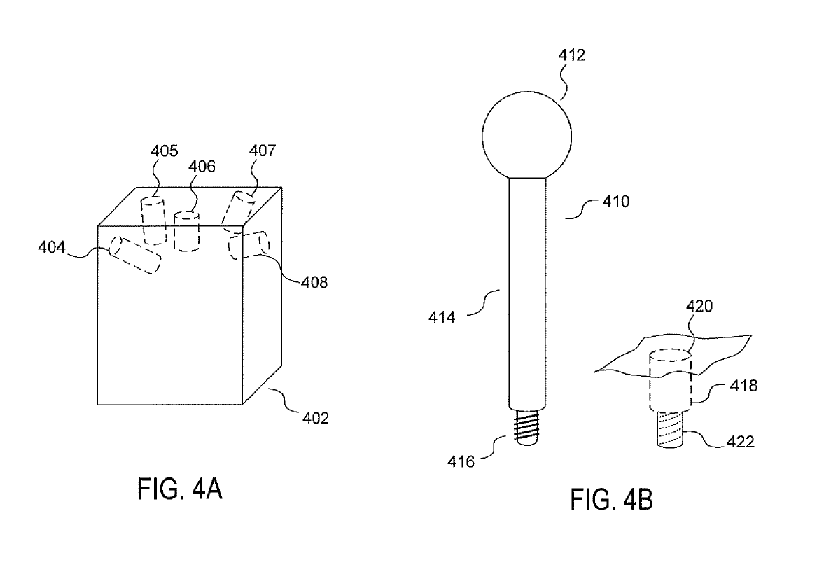

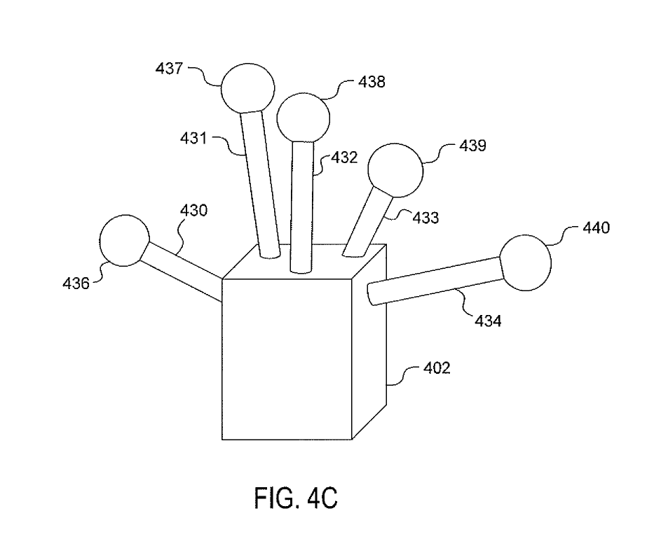

FIGS. 4A-C illustrate assembly of an optically detectable marker. As shown in FIG. 4A, the optically detectable marker includes a base element 402 having multiple anchors, shown as cylindrical invaginations 404-408. Each anchor, in the implementation shown in FIGS. 4A-C, is internally threaded to receive a complementary threaded marker shaft. Each anchor has a position, in three-dimensional Cartesian space, as well as a direction that can be described by direction cosines or by angular parameters. The direction of an anchor is coincident with the direction of the rotational axis of symmetry of the cylindrical invagination. The base element 402 may have any of many different shapes and sizes and may be fashioned of any of many different types of materials, from metal or polymeric materials to various complex manufactured materials with different local compositions. The base element may include a harness, straps, magnets, hook-and-loop fasteners, snap fasteners, or other types of fastening mechanisms that allow the base element to be securely attached to a participant or physical object. Although, the implementation discussed in FIGS. 4A-C uses threaded cylindrical invaginations as anchors, many other types of anchors can be used in alternative implementations, including non-threaded cylindrical invaginations that secure marker shafts by fit and friction as well as any of a large number of different types of mechanical devices that can be manipulated to securely grasp a marker shaft in a fixed orientation.

FIG. 4B shows an example marker and additional details of an anchor in which the marker is inserted. The marker 410 includes a spherical reflective optical marker 412 and a marker shaft 414 with a threaded end 416. The threaded end 416 has a diameter smaller than the diameter of the marker shaft 414. The anchor 418 is a two-part cylindrical invagination including a first part 420 having a diameter slightly larger than the diameter of the marker shaft 414 and a second part 422 having a diameter slightly larger than the smaller diameter of the threaded end 416 of the marker shaft and having internal threads complementary to the threads of the threaded end 416 of the marker shaft 414. The threaded end 416 of the marker 410 is inserted into the anchor 418 until the threads on the threaded end engage with the internal threads of the second part 422 of the anchor and is then rotated to screw the marker into the anchor. Once screwed in, the marker is securely fastened to the base element 402 in an orientation characterized by the direction of the anchor, with the relative position of the optical marker 412 with respect to the base element computable from the anchor direction and a combination of the length of the marker shaft protruding from the base element and the radius of the optical marker 412. The currently described marker is but one of many different possible marker implementations.

FIG. 4C illustrates an assembled optically detectable marker. As shown in FIG. 4C, five markers 430-434 have been screwed into the five anchors (404-408 in FIG. 4A) of the base element 402. The five spherical optical markers 436-440 are held in a fixed arrangement in three-dimensional space. A large number of alternative arrangements can be obtained by changing the lengths of the marker shafts. For example, when there are five different shaft lengths available, there are potentially 3125 different possible arrangements of five optical markers in three-dimensional space that can be generated using the base element 402, and even more when the number of optical markers in the arrangements can be varied. It would thus appear to be relatively straightforward to be able to assemble five or 10 unique optically detectable markers when there are five different shaft-length choices for each of the markers mounted to the base element 402.

Alternative implementations may include active light-emitting optical markers rather than reflective optical markers, including light-emitting diodes, and may embed multiple light-emitting optical markers in a matrix or network that can be individually illuminated, to allow subsets of the light-emitting optical markers to be illuminated to generate different configurations of the optical elements. As discussed further, below, two fundamental properties of a set of optically detectable markers that include optical markers are: (1) that the optical markers of a given optically detectable marker are arranged in space to be uniquely identifiable from those of the other optically detectable markers of the set; and (2) that the arrangement of optical markers of a given optically detectable marker is automatically identifiable regardless of the orientation of the arrangement of optical markers in space. A desirable, additional third property is that the first two properties are robust to obscuration or failure of one or more optical markers in the given optically detectable marker. The current document is directed to any optically detectable marker implementation that allows for assembling sets of optically detectable markers with the properties described in this paragraph, regardless of how the arrangement of optically markers is mechanically, electrically, and/or optically generated and maintained and regardless of how the arrangement is affixed to physical objects and participants.

The problem of assembling or configuring an optically detectable marker that can be uniquely identified by an automated system for each participant and object in a monitored environment is not so easily solved, despite the seemingly large number of different arrangements of optical markers in three-dimensional space provided by a handful of anchors and a modest number of shaft-length choices, in the case of the implementation shown in FIGS. 4A-C, or despite the large number of arrangements of optical markers provided by alternative implementations. First, there are numerous constraints with respect to how far apart optical markers need to be positioned in order to be separately imaged and detected by an automated, camera-based monitoring system. Second, there are significant constraints with respect to the overall dimensions of the arrangements of optical markers in space. Clearly, were an arrangement of optical markers to exceed a threshold size, wearing the optically detectable marker corresponding to the arrangement would result in significant restrictions on the movements and interactions of participants in the monitored environment. There are also constraints with regard to how similar one arrangement can be to another. The automated, camera-based monitoring system needs to be able to detect clear differences in the optically detectable marker affixed to one participant with respect to the optically detectable markers affixed to the remaining participants and objects. Two different groups of shaft lengths assigned to the anchors in a base element may nonetheless produce two similar arrangements of optical markers in three-dimensional space that cannot be distinguished from one another by the automated, camera-based monitoring system. Finally, in order for the automated, camera-based monitoring system to determine both the position and orientation of an optically detectable marker, the optically detectable marker needs to produce a different optical signal, or image, for each different orientation.

The various constraints result in a very high likelihood that random selection of shaft lengths or even application of empirical methods for selecting shaft lengths will produce optically detectable markers that fail to distinguish one participant or object from others and fail to provide a basis for unambiguous orientation determination. Moreover, it is not possible to manually or mentally evaluate optically detectable marker for unique identifiability and for providing sufficient information to identify each possible orientation of the optically detectable marker.

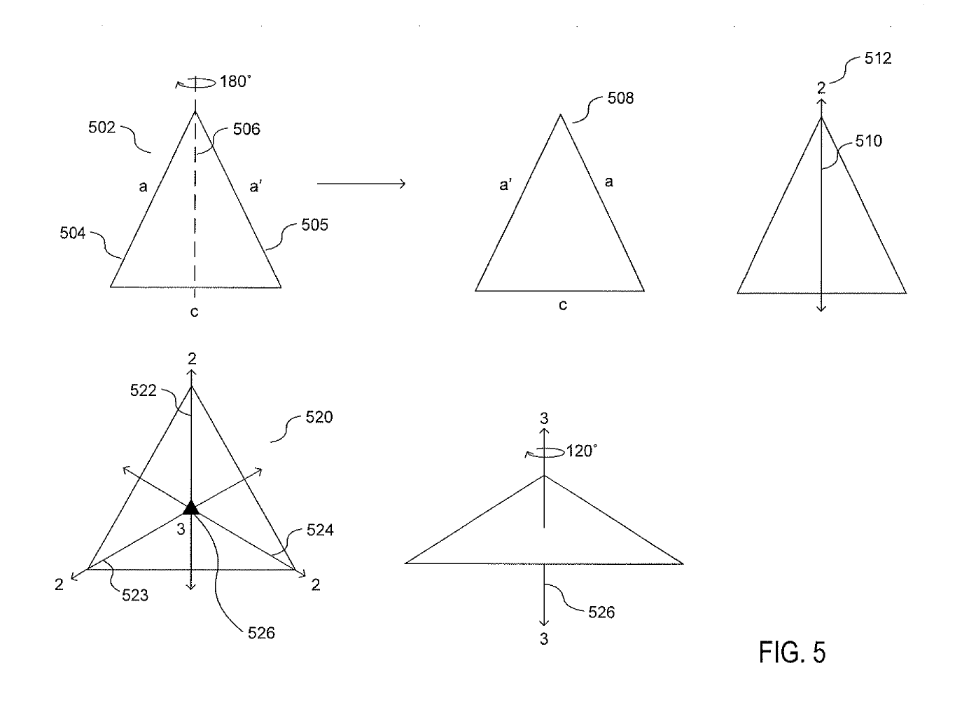

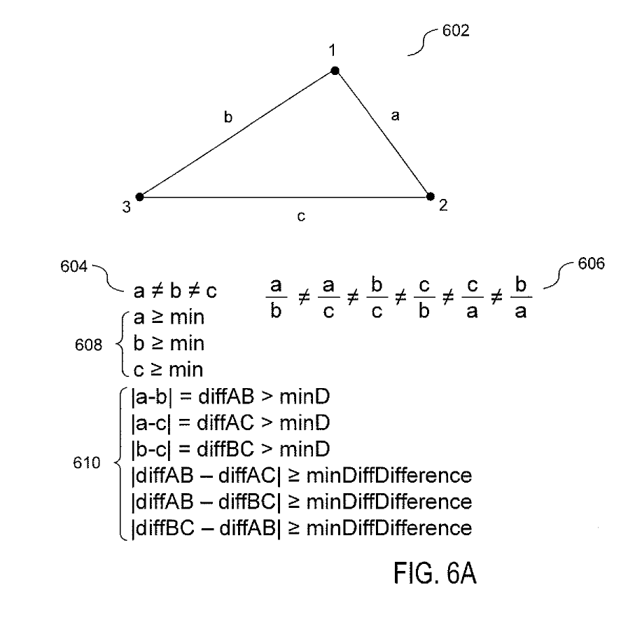

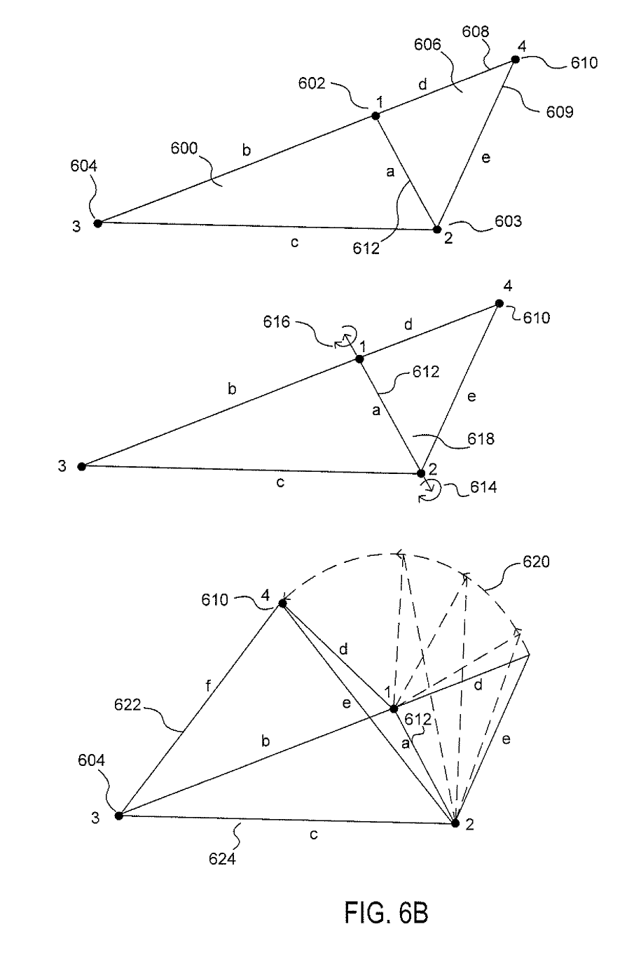

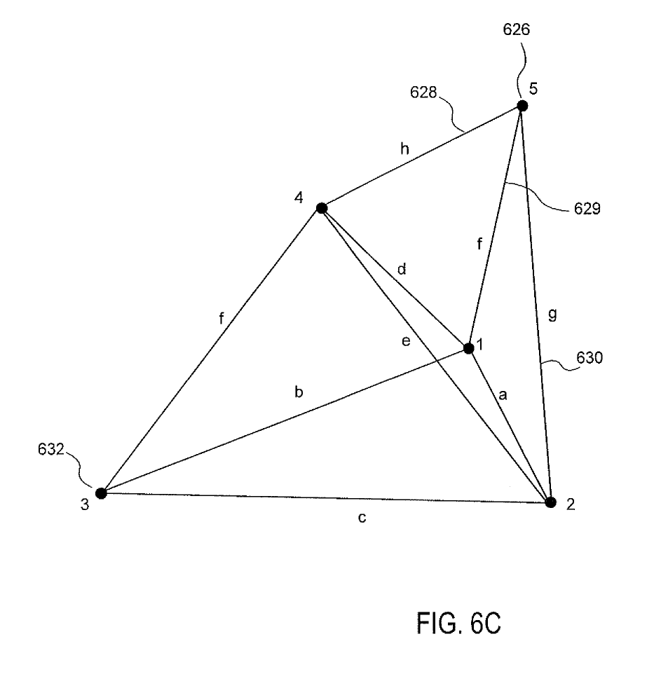

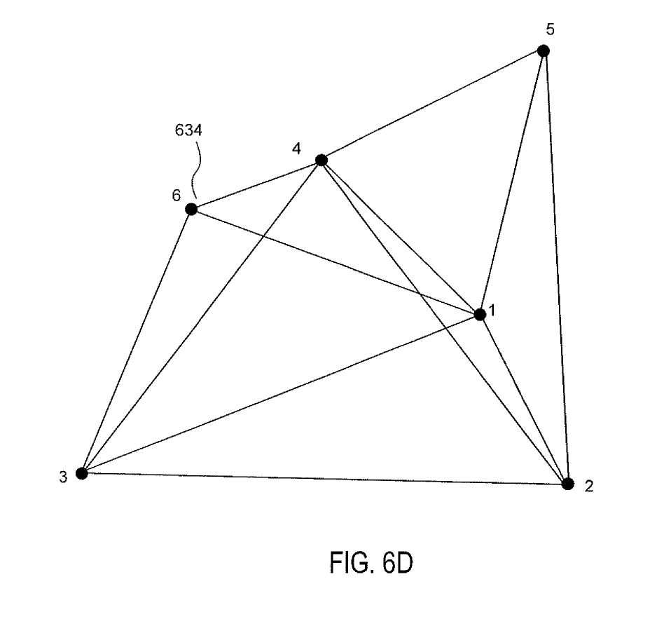

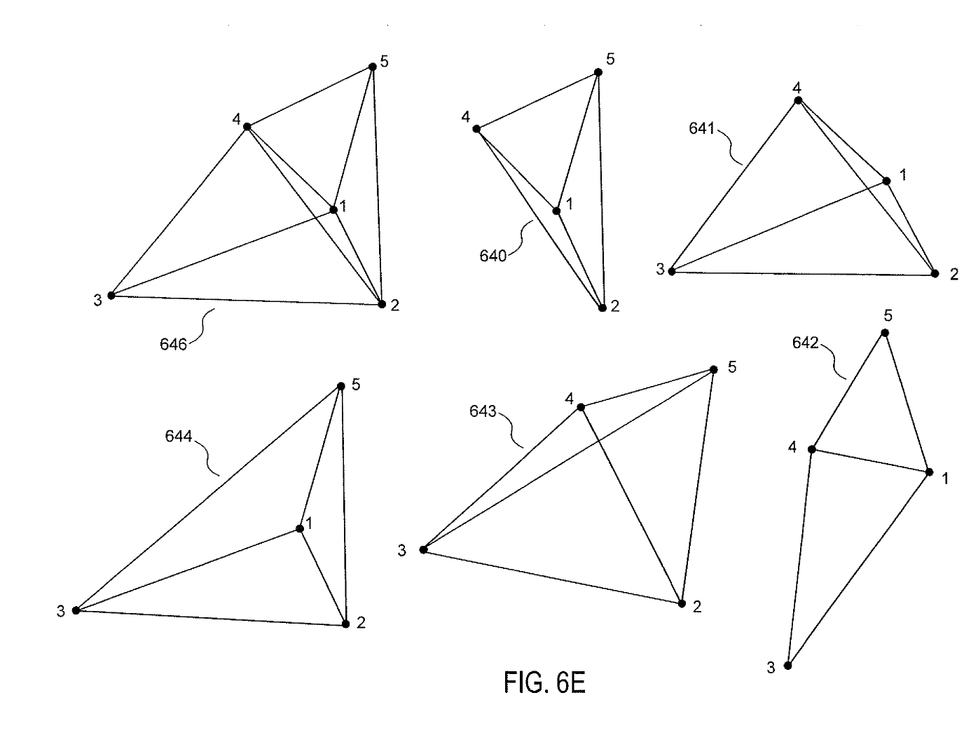

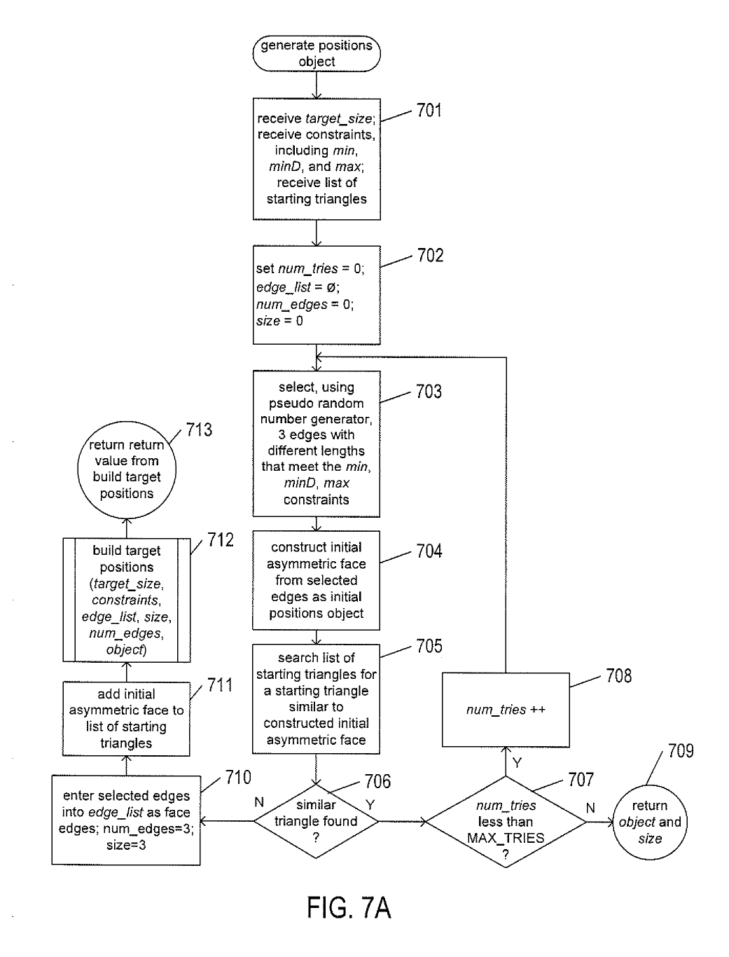

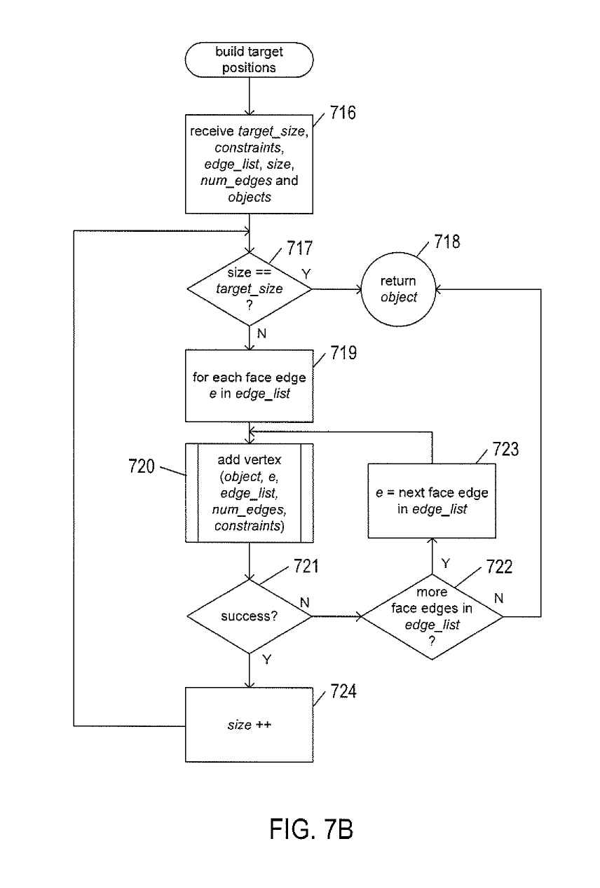

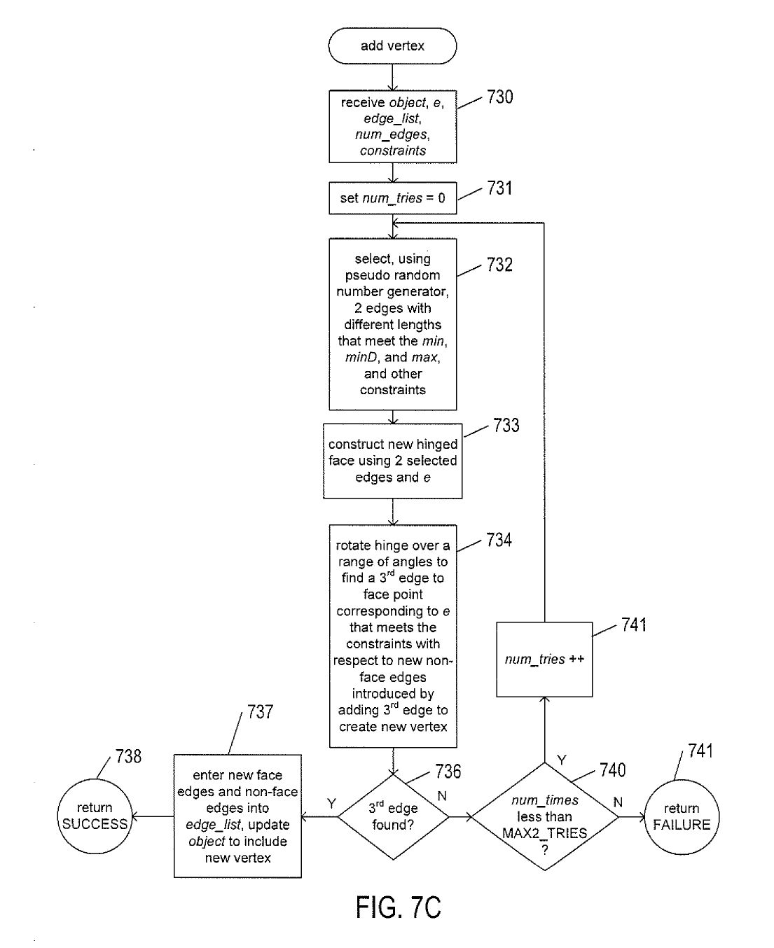

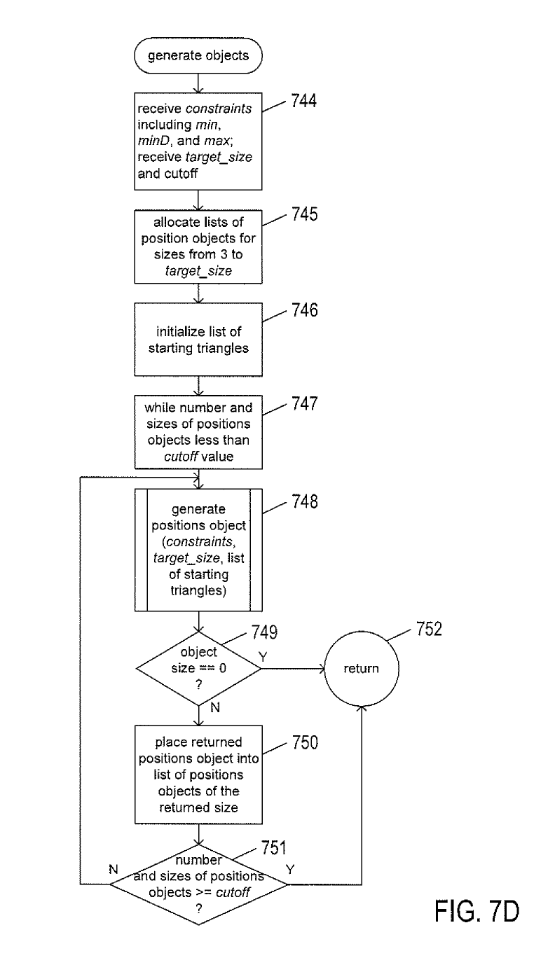

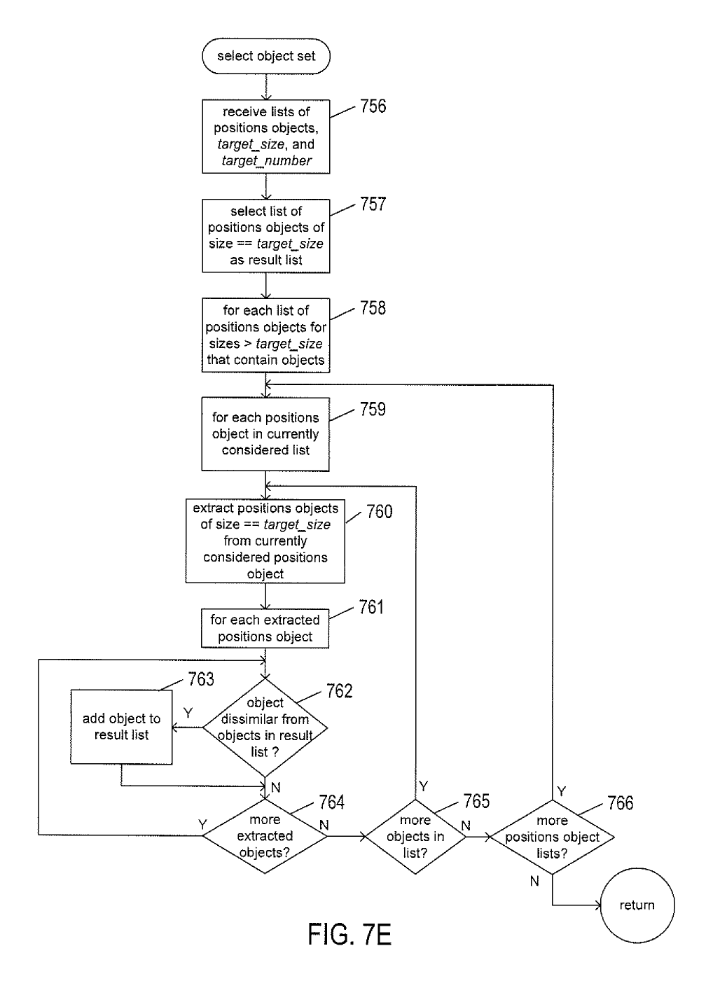

FIGS. 5-6E illustrate the currently described methods for constructing optically detectable markers that satisfy the above-mentioned constraints and that therefore produce sets of optically detectable markers in which each optically-detectable-marker member is uniquely distinguishable from the other members of the set by an automated, camera-based monitoring system and each optically-detectable-marker member provides a sufficient optical signal, regardless of orientation, to allow the automated camera-based automation system to unambiguously determine the orientation of the optically detectable marker in three-dimensional space. The currently described methods are first discussed, in overview, with reference to FIGS. 5-6E and then discussed, in greater detail, with reference to FIGS. 7 A-E.

Initially, a three-optical-marker arrangement is considered. When three optical markers are not located along a single line, the three optical markers can be considered to represent the vertices of a triangle. FIG. 5 illustrates rotational symmetry associated with several types of triangles. An isosceles triangle 502 has two sides 504 and 505 of the same length, labeled a and a′ in FIG. 5. As a result, a two-fold symmetry axis, shown in FIG. 5 by a dashed line 506, bisects the isosceles triangle in the plane of the triangle. Rotation of the isosceles triangle by 180° about this two-fold rotation axis produces an isosceles triangle 508 in which the positions of the two sides with identical lengths are interchanged. However, neglecting the labeling of the sides, the rotated isosceles triangle 508 is identical to the original isosceles triangle 502. Rotational symmetry thus is a symmetry operation that, when performed on an object, produces a differently oriented object that appears identical to the original object. A two-fold rotation axis in the plane of the diagram is represented by a double-handed arrow, such as double-handed arrow 510, and labeled with the number “2” 512 that indicates the number of identical orientations of the object produced by the rotation axis. A two-full rotation axis rotates an object by 180° and therefore produces only two identical objects related by rotational symmetry. An arrangement of optical markers that places the three optical markers at the vertex positions of an isosceles triangle would not be suitable for an optically detectable marker, since an image of the optically detectable markers would not indicate from which side of the plane of the triangular arrangement of the three optical markers the optical markers were imaged. Whenever an arrangement of optical markers includes rotational symmetry, there is an ambiguity in the absolute orientation of the arrangement of optical markers in three-dimensional space corresponding to an image of the object. Of course, and certain special orientations, there may be greater degree of ambiguity. For example, were the three optical markers imaged in an orientation in which they appear to be positioned along a single line or, in other words, when the triangle described by the three optical markers is viewed edge-on, there is greater ambiguity in the absolute orientation of the three optical markers.

An equilateral triangle 520 has much greater rotational symmetry than an isosceles triangle. An equilateral triangle includes three different two-fold rotation axes 522-524 in the plane of the triangle as well as a three-fold rotation axis 526 orthogonal to the three 2-fold rotation axes. Thus, were the three optical markers of an optically detectable marker arranged to coincide with the vertices of an equilateral triangle, the arrangement would be even less suitable than were there positions to coincide with an isosceles triangle.

FIGS. 6A-E illustrate a method for ensuring that an arrangement of optical-marker positions in three-dimensional space is suitable for use as an optically detectable marker. As shown in FIG. 6A, the minimum number of optical markers that can be positioned in space to provide sufficient information for unambiguous determination of both the position and orientation of the arrangement of optical markers by an automated, camera-based monitoring system is three. The three optical markers must be positioned at the vertices of a scalene triangle 602 in which no side has a length equal to another side of the triangle. A scalene triangle has no rotational symmetry and therefore no orientation ambiguity due to rotational symmetry can be introduced into an optical image. Thus, a scalene triangle inherently satisfies a constraint that all of the sides of the triangle have different lengths 604 and that the ratios of the length of one side to another all have different values 606. In addition, to ensure adequate separation between optical markers, the lengths of all of the sides of the triangle need to be greater than or equal to a minimum, threshold distance 608. Finally, the absolute values of the differences between the lengths of each possible pair of sides need to be greater than or equal to a minimum threshold distance difference 610 to ensure that all three sides of the triangle have sufficiently different lengths to allow for unambiguous identification and orientation determination by an automated, camera-base monitoring system and the differences between the pairs of side lengths need also to be different from one another by a value greater than or equal to a minimum distance difference. These constraints are informed by various characteristics and parameters of camera-based imaging as well as the sizes, shapes, and other characteristics of the optical markers and optical-marker shafts. A three-optical-marker arrangement that satisfies these constraints is necessarily a scalene triangle and is referred to, in the following discussion, as an “asymmetrical face.”

FIG. 6B illustrates a method for adding a fourth vertex to an asymmetrical face in order to produce a 4-sided polyhedron without rotational symmetry. The asymmetrical face includes the three vertices 602-604. The three sides of the scalene triangle, as discussed above with reference to FIG. 6A, have three different lengths. In a first step, a second scalene triangle 606 is constructed from two new edges 608-609 and the fourth vertex 610 along with one of the edges 612 of the asymmetric face. The lengths of the two new edges must be different from one another and from all of the edges of the asymmetric face 600. Then, the new vertex 610 is rotated about the selected edge 612 of the asymmetric face, with the rotation shown by curved arrows 614-616 and a double-handed arrow 618. The new scalene triangle can be considered to be a hinged asymmetrical face. The fourth vertex 610 traces out a circular path, as shown by a semi-circular dashed line 620 in FIG. 6B, as the hinged asymmetric face is rotated about the selected edge 612 of the asymmetric face. The fourth vertex is rotated to a position in which the distance between the fourth vertex 610 and the vertex 604 of the asymmetric face that does not lie on the selected edge 612 differs from the lengths of any of the edges of the asymmetrical face and the two new edges, in one implementation, or, in other implementations, this constraint may be relaxed provided that no rotational symmetry is introduced into the 4-sided polyhedron and any higher-degree polyhedra that includes the 4-sided polyhedron, when the vertex is being added to an asymmetric face of a polyhedron. In this position, a sixth new edge 622 is formed between the new fourth vertex 610 and the vertex 604 of the asymmetric face that does not lie on the selected edge 612. The resulting four-vertex polyhedron has no rotational symmetry. No two faces of this four-vertex polyhedron are identical. Therefore, the positions of the four vertices of the four-vertex polyhedron 624 are suitable positions for four optical markers suitable for an optically detectable marker.

As shown in FIG. 6C, a fifth vertex 626 can be added to the face of a four-vertex asymmetrical polyhedron using the method discussed above with reference to FIG. 6B and additionally ensuring that, in the example shown in FIG. 6C, all three new additional edges 628-630 are different from one another and different from all of the edges of the four-vertex polyhedron to which the fifth vertex 626 is added. There is an additional new implied edge between the new vertex 626 and the vertex 632 that does not lie on the asymmetrical face of the four-vertex polyhedron to which the new vertex 626 is added by the method discussed above with reference to FIG. 6B. This implied edge needs also to have a length different from the lengths of all of the edges of the four-vertex polyhedron and the three newly added edges 6 to 8-630. As shown in FIG. 6D, a sixth vertex 634 can be added to a five-vertex asymmetrical polyhedron by again using the same technique illustrated in FIG. 6B to be to add a new vertex to an asymmetrical face.

As shown in FIG. 6E, five 4-vertex asymmetrical polyhedra 640-644 can be extracted from a 5-vertex asymmetrical polyhedron 646 by selecting the positions of each possible combination of four vertices from the five-vertex asymmetrical polyhedron 646. When constructed by the methods described with reference to FIGS. 6 A-D, the 5-vertex asymmetrical polyhedron 646 contains no rotational symmetry and the four-vertex polyhedron and three-vertex scalene triangles extracted from the five-vertex asymmetrical polyhedron also contain no rotational symmetry.

In general, optically detectable markers with at least four optical markers are desirable. A given optically detectable marker with four optical markers has sufficient redundancy to enable the optically detectable marker to be uniquely identified even when one of the four optical markers is obscured, provided that no other four-optical-marker optically detectable marker concurrently used in the monitored environment shares a common asymmetrical face with the given optically detectable marker. Furthermore, even when one of the four optical markers is obscured, an automated, camera-based monitoring system can uniquely determine the orientation of the optically detectable marker from the positions of the three optical markers that are imaged. A set of optically detectable markers each including an arrangement of five optical markers is suitable for automated, camera-based monitoring when no two optically detectable markers share a common polyhedral subset with four vertices and no common asymmetrical face. In certain cases, it may be desirable to include additional constraints with regard to potential imaging ambiguities. In a monitoring system that can accurately detect the ratios of the distances between two pairs of optical markers but that cannot accurately detect the absolute distances between the optical markers in each pair, it may be necessary to add a constraint to avoid the presence of polyhedral subsets of an arrangement of optical markers that include a pair of polyhedral that differ only in scale or dimension.

FIGS. 7A-E provide control-flow diagrams that illustrate one implementation of a system and method for generating positions objects that each describe an arrangement of optical markers in three-dimensional space that lack rotational symmetry and that meet various distance constraints. The positions objects can be used to generate sets of optically detectable markers, with the position and orientation of each optically detectable marker in the set uniquely identifiable by an automated camera-based monitoring system. A positions object includes coordinates for each vertex.

FIG. 7A provides a control-flow diagram for a routine “generate positions object” that attempts to generate an asymmetric polyhedron with a target number of vertices. In step 701, the routine receives an argument target size, which is the target number of vertices for the desired asymmetric polyhedron, and encodings of a number of constraints, mentioned above, including: (1) min, the minimum distance between optical markers; (2) minD, the minimal difference between the distances between two pairs of optical markers; and (3) max, the maximum dimension of an arrangement of optical markers in three-dimensional space. Note that the control-flow diagrams assume that, in general, arguments are passed by reference, allowing called routines to modify the arguments. As also discussed above, additional constraints based on the particular characteristics and parameters of an automated, camera-based monitoring system may also be included in the set of constraints used to construct positions objects. The routine “generate positions object” also receives a list of starting triangles used in previous calls to the routine. In step 702, the routine initializes the local variable num_tries to 0, the local list edge_list to the empty list, the local variable num_edges to 0, and the local variable size to 0. The local variable num_tries is used to count the number of attempts to construct an initial scalene triangle. The local list edge_list stores all of the asymmetric-face edges so far included in an asymmetric polyhedron represented by the positions object being constructed as well as the implicit, non-face edges. The local variable num_edges stores an indication of the number of edges in the list edge_list. The local variable size stores the number of vertices in the asymmetric polyhedron that is being constructed by the routine “generate positions object.” In step 703, the routine selects, using a pseudo-random number generator, three edges with different lengths that meet the received constraints. In step 704, the three edges are used to construct an initial asymmetric face from the three selected edges as an initial positions object. In step 705, the routine searches the received list of starting triangles to determine whether there is already a triangle in the list of starting triangles similar to the initial asymmetric face constructed in step 704. When a similar triangle is found in the list of starting triangles, as determined in step 706, then, when the value in local variable num_tries is less than a maximum value MAX_TRIES, as determined in step 707, the value in the local variable num_tries is incremented, in step 708, and control flows back to step 703, where the routine attempts to generate a different initial asymmetric face, or triangle. When the value stored in the local variable num_tries is greater than or equal to MAX_TRIES, as determined in step 707, a size value of 0 is returned, in step 708 to indicate failure. When no similar triangle is found in the list of starting triangles, as determined in step 706, then the three edges selected in step 703 are entered into the list edge_list, the local variable num_edges is set to the value 3, and the variable size is set to the value 3 in step 710. The initial asymmetric face is added to the list of starting triangles in step 712. A call is made to the routine “build target positions,” in step 714, and the value returned by that routine is returned in step 713.

FIG. 7B provides a control-flow diagram for the routine “build target positions,” called in step 712 of FIG. 7A. In step 716, the routine “build target positions” receives the target size, constraints, the list edge_list, size, num_edges, and a positions object. When the value in size is equal to the target size, as determined in step 717, the positions object are returned in step 718. Otherwise, in the for-loop of steps 719-722, the routine attempts to add a new vertex to each asymmetric-face edge e in the list edge_list by the method discussed above with reference to FIG. 6B until either there are no more asymmetric-face edges to which to attempt to add a new vertex or until a new vertex is successfully added. In step 720, the routine “build target positions” calls the routine “add vertex” to attempt to add a vertex to asymmetric-face edge e. When a vertex is successfully added by the routine “add vertex,” as determined in step 721, the variable size is incremented, in step 724 and control breaks out of the for-loop of steps 719-722 and returns to step 717. Otherwise, when there are more face edges in the list edge_list, as determined in step 722, a next asymmetric-face edge e is selected from the list edge_list, in step 723, and control returns to step 720, where the asymmetric-face edge e is used for a next attempt to add a vertex. When there are no more unconsidered asymmetric-face edges in the list edge_list, as determined in step 722, the positions object is returned, in step 718. Thus, the routine “build target positions” continues to attempt to add vertices to faces of an asymmetric polyhedron until either a desired number of vertices is achieved or no further vertices can be added.

FIG. 7C provides a control-flow diagram for the routine “add vertex,” called in step 720 of FIG. 7B. In step 730, the routine “advert tax” receives a position object, and edge e, a list edge_list, num_edges, and a set of constraints. In step 731, the routine sets a local variable num_tries to 0. In step 732, the routine selects, using a pseudorandom number generator, two edges with different lengths that meet the various constraints with respect to all edges in the list edge_list. In step 733, the routine constructs a new hinged face, as described with reference to FIG. 6B, using the two selected edges and the received edge e. Then, in step 734, the new hinged face is rotated over a range of angles until a new third edge is created between the new vertex of the new hinged face and the vertex of the asymmetric face to which the new hinged face is added that is not positioned on edge e, with the new third edge meeting all of the constraints with respect to the edges in the list edge_list as well as the two selected edges. When a third edge is successfully found, as determined in step 736, the new face edges and any non-face edges introduced by introduction of the new vertex are added to the list edge_list and the positions object is updated to include the new vertex in step 737. A success value is returned in step 738. Otherwise, when the value stored in the local variable num_tries is less than a threshold value MAX2_TRIES, as determined in step 740, the variable num_tries is incremented, in step 741, and control returns to step 732 to attempt again to add a vertex to the positions object. Otherwise, when the value stored in the local variable num_tries is greater than or equal to MAX2_TRIES, as determined in step 740, a failure indication is returned in step 741.

FIG. 7D provides a control-flow diagram for the routine “generate objects.” This routine attempts to generate a positions object with a target number of vertices. However, in the course of attempting to generate a positions object with the target number of vertices, positions objects that are successfully generated with a fewer number of vertices are maintained in a set of lists of positions objects. In step 744, the routine “generate objects” receives a set of constraints, a target size, and a cutoff parameter. The cutoff parameter is a calculated value that indicates when a sufficient number of positions objects with various numbers of vertices have been created. This computed value may weight the numbers of positions objects with particular numbers of vertices by the number of vertices as well as by other factors. In step 745, the routine “generate objects” allocates a list of positions objects for each size, or number of vertices, from 3 up to the target size. In step 746, the routine “generate objects” initializes a list of starting triangles to the empty list. Then, in the while-loop of steps 747-752, the routine “generate objects” continuously attempts to generate positions objects of the target size until a sufficient number of positions objects have been generated to satisfy the cutoff value. In step 748, the routine “generate positions object,” discussed above with reference to FIG. 7A, is called. When the returned object size is 0, as determined in step 749, the routine “generate objects” returns, in step 752. Otherwise, in step 750, the returned positions object is entered into the list of positions objects of the returned size. When the total number of positions objects so far created has not yet satisfied the cutoff requirement, as determined in step 751, control returns to step 748 to generate a next positions object. Otherwise, the routine “generate objects” returns in step 752.

FIG. 7E provides a control-flow diagram for a routine “select objects set.” This routine generates a set of positions objects of a target size suitable for describing a set of object-marker arrangements that can be used to produce a set of optically detectable markers, the positions and orientations of which can be uniquely determined by an automated, camera-based monitoring system. In step 756, the routine “select objects set” receives lists of positions objects and a target number. The list of positions objects is generated by the routine “generate objects,” discussed above with reference to FIG. 7D. In step 757, the list corresponding to position objects of the target size is selected as the result list. The list is filtered to remove any objects that describe position arrangements similar to the position arrangement described by another of the objects in the list. Note that, in practice, the target size with which the routine “select objects set” is called is generally significantly less than the target size with which the routine “generate objects” is called. It is desirable to generate an asymmetric polyhedron with a number of vertices greater than the number of optical markers desired to be included in the set of optically detectable markers, so that a sufficient number of optical-marker arrangements can be extracted from the asymmetric polyhedron, as discussed above with reference to FIG. 6E. However, because of the rigorous constraints used in polyhedron construction, it may not be possible to generate an asymmetric polyhedron of a desired size. Therefore, the routine “generate objects” maintains asymmetric polyhedra of less than the desired size from which asymmetric polyhedra of the target size can be extracted. In an outer for-loop of steps 758-766, each list of positions objects with sizes greater than or equal to the target size are considered, starting with the list that contains objects of the greatest size and working downward to the list that contains objects of the target size. In the first inner for-loop of steps 759-765, each positions object in the currently considered list is considered. In step 760, positions objects of the target size are extracted from the currently considered positions object, as discussed above with reference to FIG. 6E. In the innermost for-loop of steps 761-764, each of the positions objects extracted in step 760 is considered. When the extracted object is dissimilar from all of the positions objects currently residing in the result list, as determined in step 762, the object is added to the list result_list. As discussed above, the similarity determination is based on determining that the object does not include any polyhedra or triangles similar to polyhedra or triangles in the objects already in the result list. The similarity criteria depend on the characteristics and parameters of the automated, camera-based monitoring system. In certain cases, when all of the asymmetric faces of the polyhedron described by the positions object are unique with respect to other positions objects and the result list, the positions object represents an arrangement that is dissimilar from the arrangements represented by the positions objects currently residing in the result list.

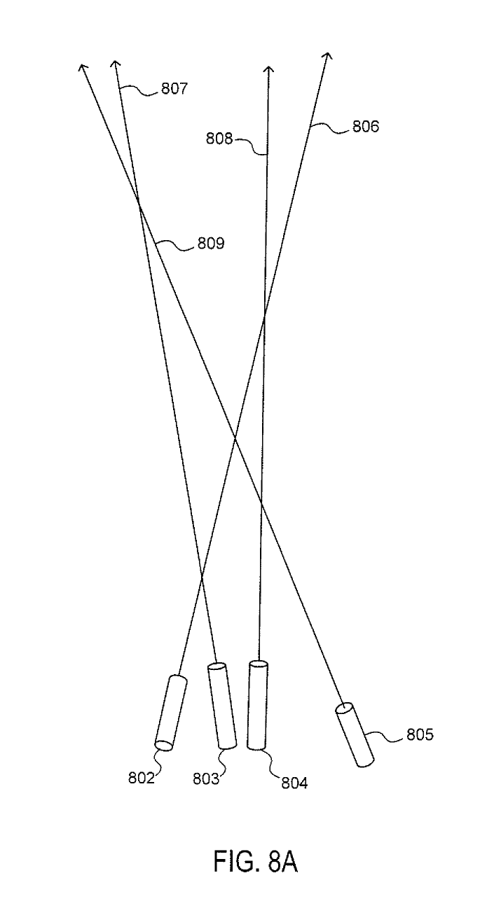

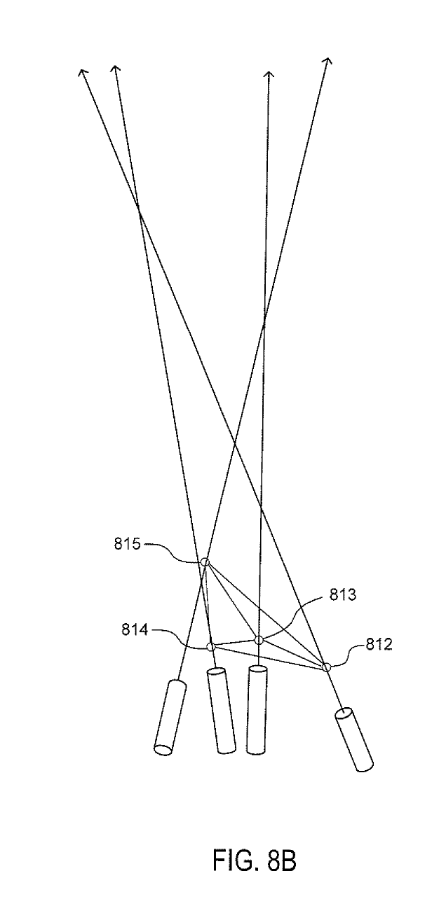

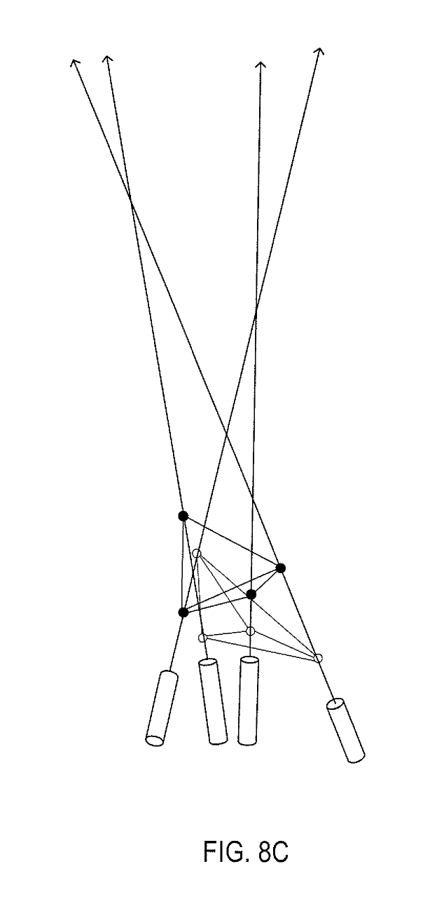

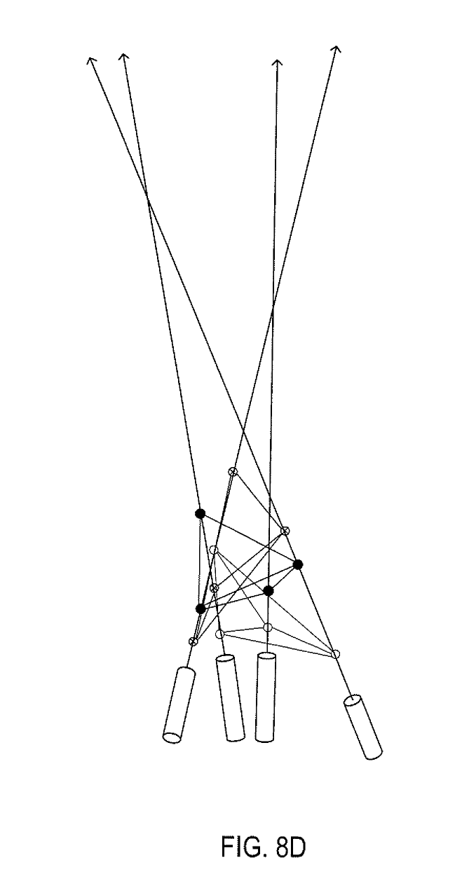

FIGS. 8A-D illustrate a further consideration in the construction of optically detectable markers. In FIG. 8A, four anchors 802-805 are shown along with representations of the directions of their axes of rotational symmetry 806-809. As discussed above, the positions of the anchors and their directions, combined with the lengths of the shafts of the markers inserted into the anchors, defines the three-dimensional arrangement of the optical markers. As an example, as shown in FIG. 8B, the four optical-marker positions 812-815, each coincident with one of the four anchor directions, and thus define a four-vertex polyhedron representing an arrangement of optical markers that can be obtained by selecting optical-marker shafts with lengths needed to position the optical markers along the anchor directions in the indicated positions. It is desirable to reuse anchors, as much as possible, to generate other unique arrangements of optical markers corresponding to other optically detectable markers. In this way, manufacturing costs for base elements is minimized as is the complexity associated with assembling optically detectable markers from a base element and markers with different shaft lengths. Of course, there is a trade-off between minimizing the number of anchors needed to produce a set of optically detectable markers using the same base element and minimizing the number of different shaft lengths needed to assemble each of the optically detectable markers in the set of optically detectable markers. Nonetheless, it is generally desirable to minimize the number of anchors. Therefore, when a second, different arrangement of optical markers can be obtained using the same set of four anchors, as shown in FIG. 8C, the number of anchors needed to generate both arrangements is minimized. FIG. 8D shows three different arrangements of optical markers obtained using the same for anchors shown in FIG. 8A. Of course, it is often impossible to generate all of the needed optically detectable markers of a given target size from a number of anchors equal to the target size.

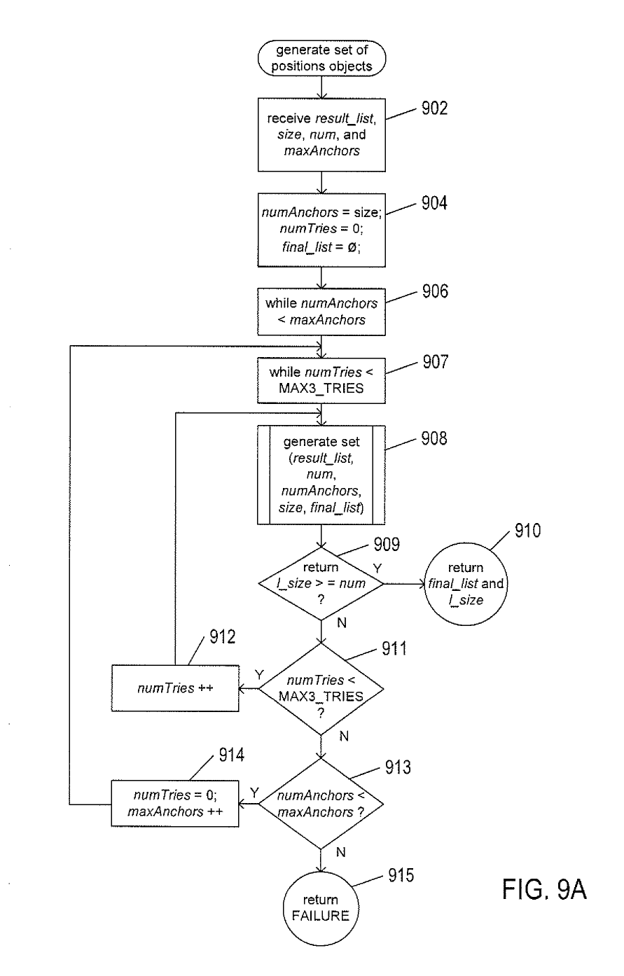

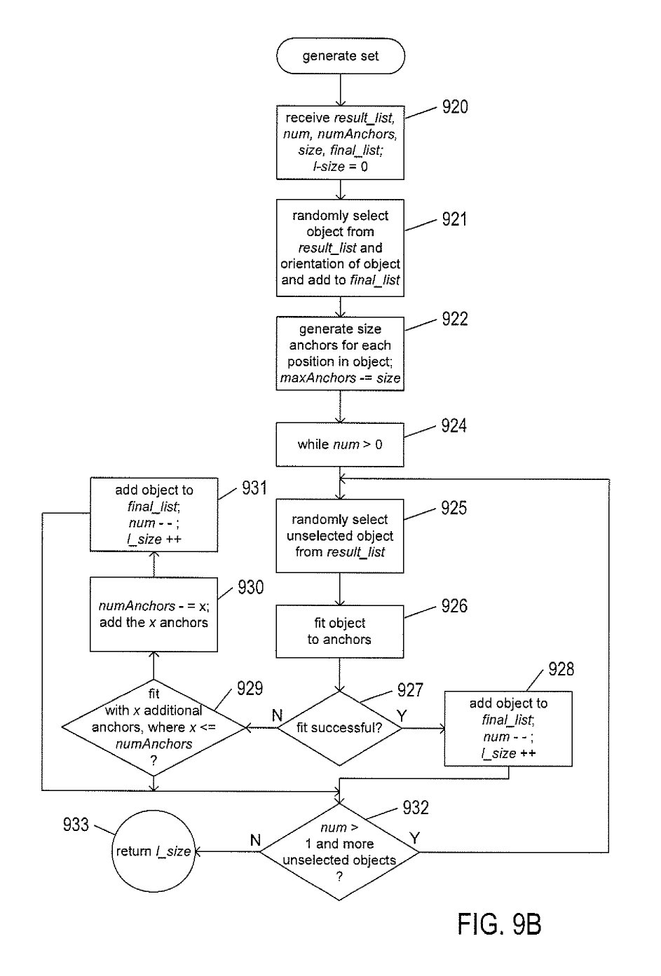

FIGS. 9A-B illustrate an implementation of a method that generates a set of positions objects with a minimum number of anchors. This method is easily adapted to generate a minimum number of active light-emitting optical markers for optically detectable markers that employ active light-emitting optical markers that are switched on and off to generate different, uniquely identifiable optically detectable markers.

FIG. 9A provides a control-flow diagram for a routine “generate set of positions objects.” In step 902, the routine “generate set of positions objects” receives an argument result-list that references a list of positions objects generated by the routine “select object set,” discussed above with reference to FIG. 7E, an argument size that indicates the target size of the positions objects, an argument num that indicates a desired number of positions objects in the set, and an argument maxAnchors that indicates the maximum number of anchors desired. In step 904, a local variable numAnchors is initialized to the value stored in argument size, a local variable numTries is set to 0, and a local list variable final_list is initialized to be empty. In an outer while-loop of steps 906-915, the routine “generate set of positions objects” iteratively calls a routine “generate set,” in step 908, to generate a set of positions objects with a number of anchors equal to the current value in the local variable numAnchors. The value stored in the local variable numAnchors is incremented prior to each subsequent iteration. When the value stored in the local variable numAnchors exceeds the value received in argument maxAnchors, the outer while-loop of steps 906-915 returns a FAILURE indication, in step 915. Otherwise, a set of positions objects is returned in step 910. In an inner while-loop of steps 907-912, the routine “generate set” is called, in step 908, to generate a set of positions objects with a number of anchors equal to the current value in the local variable numAnchors. When a set of positions objects is successfully generated, the set of positions objects and the number of positions objects in the set are returned in step 910. Otherwise, when the value stored in local variable numTries is less than a threshold value MAX3_TRIES, another iteration of the inner while-loop ensures, to again try to generate a set of positions objects with a number of anchors equal to the current value in the local variable numAnchors. When the value stored in local variable numTries is greater or equal to the threshold value MAX3_TRIES, the inner while-loop terminates and control flows to step 913 of the outer while-loop.

FIG. 9B provides a control-flow diagram for the routine “generate set,” called in step 908 of FIG. 9A. In step 920, the routine “generate set” receives a list result_list of objects, a target number of optically detectable markers num, an indication of the maximum number of anchors desired, maxAnchors, an indication of the size of the positions objects in the list result_list, size, a list of positions objects corresponding to arrangements of optical markers for the set of optical-marker detectors, final_list, and an indication of the number of objects in the list final_list, lsize. In step 921, a positions object is randomly selected from the list result_list and is oriented in a randomly selected orientation. The positions object is then entered into the list final_list. In step 922, anchors are generated for each position in the object and the received indication of the maximum desirable number of anchors is decremented by the number of generated anchors. Then, in the while-loop of steps 924-933, additional positions objects are selected from the list result_list in order to construct a set of positions objects corresponding to a set optically detectable markers, each of which is uniquely identifiable and meets the various constrains. The while-loop of steps 924-933 iterates until the desired number of positions objects have been entered into the list final_list or until it is determined that a set of optically detectable markers that meet the number-of-anchors constraint cannot be obtained. In step 925, the routine “generate set” randomly selects an as yet unselected object from the list result_list. In step 926, the routine attempts to fit the object to the current set of anchors, as discussed above with reference to FIGS. 8A-D. When the fit is successful, as determined in step 927, then the selected object is added to the list final_list, the variable num is decremented, and the variable lsize is incremented in step 228. Otherwise, when the object can be fit by adding x additional anchors, where x is less than or equal to the current value of number anchors, as determined in step 929, then the variable num is decremented, in step 930, by x and the x additional anchors are added to the set of anchors. Then, in step 931, the selected object is added to the list final_list, the variable num is decremented, and the variable lsize is incremented. When the value stored in the variable num is greater than 1 and there are more unselected objects in the list result_list, as determined in step 932, control flows back to step 925 where the routine “generate set” attempts to add another positions object to the list final_list. Otherwise, in step 933, the routine “generate set” returns the current value of the local variable lsize.

The various operations on positions objects, discussed above, are accomplished by simple matrix multiplication of coordinate vectors by 3×3 rotation matrices to rotate an arrangement of positions and/or by adding values representing translations to the components of coordinate vectors. For example, the rotation of the fourth vertex, discussed with reference to FIG. 6B, is carried out by rotation the vertices in order to align the hinge edge with a coordinate axis and then multiplying the position vector of the fourth vertex by a 3×3 rotation matrix.

Although the present invention has been described in terms of particular embodiments, it is not intended that the invention be limited to these embodiments. Modification within the spirit of the invention will be apparent to those skilled in the art. For example, while the currently described methods seek to generate a set of optically detectable markers that all have the same number of markers, similar, alternative methods may allow for a set of optically detectable markers to include optically detectable markers with different numbers of the mounted markers. In this fashion, larger sets of optically detectable markers can be obtained due to relaxing the constraint that all of the optically detectable markers use the same number of markers. This constraint can be removed and the above-described routine “select objects that close quote by allowing for extraction of differently sized position objects from the currently considered positions objects in step 760 and combining multiple lists of position objects and the result set in step 757. While the currently disclosed methods represent one approach to computationally generating the sets of optical-marker arrangements and three-dimensional space that are each uniquely identifiable and that each slack rotational symmetry, other brute-force methods are possible. The number of uniquely identifiable optically detectable markers within a set of optically detectable markers can be constructed or configured by the above described methods depending on the applied constraints, but useful set sizes obtained by reasonable constraints can range from 2 to 5, in certain implementations, from 6 to 10, in other implementations, from 11 to 100, in still other implementations, and may exceed 100, in certain implementations.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An optically-detectable-marker set comprising:
two or more optically detectable markers, each comprising
a base element,
an attachment mechanism that attaches the base element to an object or person, and
three or more optical markers attached to, or embedded within, the base element in a spatial arrangement that lacks rotational symmetry and that is uniquely identifiable, by an automated, camera-based monitoring system, from the spatial arrangements of the optical markers attached to, or embedded within, the base elements of the other optically detectable markers in the optically-detectable-marker set.

2. The optically-detectable-marker set of claim 1 wherein the spatial arrangement of the optical markers of each optically detectable marker in the optically-detectable-marker set is uniquely identifiable, by the automated, camera-based monitoring system, when a subset of the optical markers cannot be imaged by the automated, camera-based monitoring system.

3. The optically-detectable-marker set of claim 2 wherein the number of optically detectable markers in the optically-detectable-marker set ranges from 2 to 5.

4. The optically-detectable-marker set of claim 2 wherein the number of optically detectable markers in the optically-detectable-marker set ranges from 6 to 10.

5. The optically-detectable-marker set of claim 2 wherein the number of optically detectable markers in the optically-detectable-marker set ranges from 11 to 100.

6. The optically-detectable-marker set of claim 2 wherein the number of optically detectable markers in the optically-detectable-marker set is greater than 100.

7. The optically-detectable-marker set of claim 1 wherein the attachment mechanism that attaches the base element to an object or person is selected from a set of attachment mechanisms that includes:
a hook-and-loop-based attachment mechanism;
a snap-based attachment mechanism;
a pin-based attachment mechanism;
a screw-based attachment mechanism;
a strap-based attachment mechanism; and
an elastic-band based attachment mechanism.

8. The optically-detectable-marker set of claim 1 wherein the optical markers are selected from one or more of:
passive, reflective optical markers; and
active, electromagnetic-radiation-emitting optical markers.

9. The optically-detectable-marker set of claim 1 wherein a common base element is used to construct or configure each of the optically detectable markers in the optically-detectable-marker set.

10. The optically-detectable-marker set of claim 9 wherein each optical marker is affixed to a marker shaft to compose a marker.

11. The optically-detectable-marker set of claim 10 wherein each marker is affixed to the base element by an anchor.

12. The optically-detectable-marker set of claim 11 wherein different spatial arrangements of optical markers are obtained by varying one or more of:
the number of markers;
the lengths of the marker shafts; and
the anchors selected to hold the markers.

13. The optically-detectable-marker set of claim 11 wherein the common base element contains a minimal number of anchors from which the spatial arrangements of the optical markers in each of the optically detectable markers in the optically-detectable-marker are configured.

14. The optically-detectable-marker set of claim 9 wherein the optical markers are active optical markers that emit electromagnetic radiation and wherein the optical markers are separately controlled to emit electromagnetic radiation.

15. The optically-detectable-marker set of claim 14 wherein different spatial arrangements of optical markers are obtained by varying the optical markers that are controlled to emit electromagnetic radiation.

16. A method that generates a set of optically detectable markers, the method comprising:
generating one or more asymmetric polyhedra;
using the one or more asymmetric polyhedra to generate a unique spatial arrangement of optical markers, for each optically detectable marker of the set of optically detectable markers, that lacks rotational symmetry; and
for each optically detectable marker of the set of optically detectable markers,
providing a base element, and
and configuring a set of optical markers for the base element according to the generated unique spatial arrangement of optical markers for the optically detectable marker.

17. The method of claim 16
wherein a common base element is used for each of the optically detectable markers of the set of optically detectable markers; and
wherein the unique spatial arrangements generated for the optically detectable markers of the set of optically detectable markers are configured a minimum total number of mounting positions for markers in the common base element.

18. The method of claim 16 wherein an asymmetric polyhedron is generated by:
selecting three sides of different lengths;
arranging the selected sides to form a scalene triangle that represents a first asymmetric face of a nascent polyhedron with three edges and three vertices; and
iteratively
adding an additional vertex and three additional edges, under a set of constraints, to the nascent polyhedron
until a polyhedron of a target number or vertices is generated or until no further vertices can be added under the set of constraints.

19. The method of claim 18 wherein the set of constraints includes:
each new edge must differ, in length, from all other new edges and edges already contained in the nascent polyhedron;
the absolute value of the difference between the lengths of each pair of edges in the polyhedron must be greater than or equal to a minimum difference; and
the absolute value of differences between the lengths of any two pairs of edges selected from the polyhedron must be greater than or equal to a minimum difference.

20. The method of claim 16 wherein using the one or more asymmetric polyhedral to generate a unique spatial arrangement of optical markers, for each optically detectable marker of the set of optically detectable markers, that lacks rotational symmetry further comprises one or more of;
selecting polyhedra with a number of vertices equal to a desired number of optical markers; and
extracting one or more polyhedra with a number of vertices equal to a desired number of optical markers from one or more polyhedra having a greater number of vertices than the desired number of optical markers.
